(19) United States
(12) Patent Application Publication
(10) Pub. No.: US 2024/0305033 A1
(43) Pub. Date: Sep. 12, 2024

(54) CONNECTOR

(71) Applicant: SUMITOMO WIRING SYSTEMS, LTD., Mie (JP)

(72) Inventors: Hiroaki TSUTSUMI, Mie (JP); Kazuya TAKEUCHI, Mie (JP)

(21) Appl. No.: 18/590,045

(22) Filed: Feb. 28, 2024

(30) Foreign Application Priority Data
Mar. 10, 2023 (JP) 2023-037111

(51) Int. Cl. H01R 13/504; H01R 13/436; H01R 13/6597

(52) U.S. Cl. CPC H01R 13/5045; H01R 13/4361; H01R 13/6597

(57) ABSTRACT

A connector includes an inner conductor, a die-cast outer conductor that surrounds the outer periphery of the inner conductor, a housing to which the die-cast outer conductor is fitted, and a contacting member that is to be in electric contact with an external grounding member and the die-cast outer conductor. When a side on which a partner housing is to be fitted into the housing is taken as a front side, the contacting member includes a sandwiched portion that is sandwiched between a front-facing opposed surface of the die-cast outer conductor that faces forward and a back-facing opposed surface of the housing that faces backward, a fulcrum portion that is continuous with the front side of the sandwiched portion, and an elastic contacting portion capable of being elastically deformed that extends forward from the front side of the fulcrum portion and comes into contact with the grounding member.

### CROSS-REFERENCE TO RELATED APPLICATIONS

This application is based on and claims priority from Japanese Patent Application No. 2023-037111, filed on Mar. 10, 2023, with the Japan Patent Office, the disclosure of which is incorporated herein in its entirety by reference.

### TECHNICAL FIELD

The present invention relates to a connector.

### BACKGROUND

JP 2016-207411 A discloses a connector formed by covering a housing made of a synthetic resin with a shell made of a metal. The shell is formed using a metal sheet. The shell is provided with a shell-side grounding connection portion capable of coming into elastic contact with an external casing. The configurations disclosed in JP H10-289760 A and JP 2019-140013 A, and the like are also known as a configuration capable of coming into elastic contact with an external casing (grounding member).

### SUMMARY

In a connector, in the case where communication is performed in a higher-frequency band, it is preferable that an outer conductor (shell) is configured to surround, without leaving any gaps, the periphery of an inner conductor. In order to achieve such a configuration of the outer conductor, it is conceivable to produce the outer conductor through die-casting. If the outer conductor is produced through die-casting, it is difficult to provide the outer conductor itself with a portion that comes into elastic contact with the external casing. For this reason, a technology that reliably establishes electric continuity between the external casing and the external conductor is required.

Therefore, it is an object of the present disclosure to provide a connector with improved reliability of connection between the grounding member and the die-cast outer conductor.

A connector of the present disclosure includes: an inner conductor; a die-cast outer conductor that surrounds an outer periphery of the inner conductor; a housing to which the die-cast outer conductor is fitted; and a contacting member that is to be in electric contact with an external grounding member and the die-cast outer conductor, wherein, when a side on which a partner housing is to be fitted into the housing is taken as a front side, the contacting member includes: a sandwiched portion that is sandwiched between a front-facing opposed surface of the die-cast outer conductor that faces forward and a back-facing opposed surface of the housing that faces backward; a fulcrum portion that is continuous with a front side of the sandwiched portion; and an elastic contacting portion capable of being elastically deformed that extends forward from a front side of the fulcrum portion while extending in a direction away from an outer surface of the housing and comes into contact with the grounding member.

With the present disclosure, it is possible to improve the reliability of connection between the grounding member and the die-cast outer conductor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector according to an embodiment of the present disclosure.

FIG. 2 shows a side cross-sectional view of the connector covered by a grounding member.

FIG. 3 is a perspective view showing a die-cast outer conductor.

FIG. 4 is a perspective view showing a housing.

FIG. 5 is a perspective view showing a connection member.

FIG. 6 is a back view showing the housing to which the connection member is attached.

FIG. 7 is a cross-sectional view taken along line A-A in FIG. 6.

FIG. 8 is an enlarged side cross-sectional view showing relevant portions of a sandwiched portion in the connector.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, aspects of the present disclosure will be listed and described.

(1) A connector of the present disclosure includes: an inner conductor; a die-cast outer conductor that surrounds an outer periphery of the inner conductor; a housing to which the die-cast outer conductor is fitted; and a contacting member that is to be in electric contact with an external grounding member and the die-cast outer conductor, wherein, when a side on which a partner housing is to be fitted into the housing is taken as a front side, the contacting member includes: a sandwiched portion that is sandwiched between a front-facing opposed surface of the die-cast outer conductor that faces forward and a back-facing opposed surface of the housing that faces backward; a fulcrum portion that is continuous with a front side of the sandwiched portion; and an elastic contacting portion capable of being elastically deformed that extends forward from a front side of the fulcrum portion while extending in a direction away from an outer surface of the housing and comes into contact with the grounding member.

With this configuration, when the elastic contacting portion is pressed toward the housing, a force in a direction in which the sandwiched portion is pressed against the front-facing opposed surface of the die-cast outer conductor can be applied via the fulcrum portion, thus making it possible to bring the contacting member into favorable contact with both the die-cast outer conductor and the grounding member.

(2) It is preferable that the fulcrum portion is supported by an outer surface of the housing.

With this configuration, the position of the fulcrum portion is unlikely to be shifted, and when a pressing force is applied in a direction in which the elastic contacting portion is allowed to come close to the housing, this pressing force can be efficiently converted via the fulcrum portion into a force in a direction in which the sandwiched portion is pressed against the front-facing opposed surface of the die-cast outer conductor.

(3) It is preferable that a distance from a contact position at which the elastic contacting portion is in contact with the grounding member to the fulcrum portion is larger than a direct distance from a position at which the sandwiched portion is in contact with the front-facing opposed surface to the fulcrum portion.

With this configuration, the distance from the contact position at which the elastic contacting portion is in contact with the grounding member to the fulcrum portion (i.e., a distance from the point of effort to the fulcrum) is larger than the direct distance from a position at which the sandwiched portion is in contact with the front-facing opposed surface to the fulcrum portion (i.e., a direct distance from the point of action to the fulcrum). Therefore, the force in the direction in which the sandwiched portion is pressed against the front-facing opposed surface can be more efficiently applied to the sandwiched portion.

(4) It is preferable that the housing includes a press-fitting recess that is recessed in the back-facing opposed surface, the sandwiched portion is placed in the press-fitting recess in a press-fitted state, and the press-fitting recess is blocked by the front-facing opposed surface in a state in which the die-cast outer conductor is attached.

With this configuration, it is easy to simplify a mold structure for forming the press-fitting recess in the housing.

(5) It is preferable that the sandwiched portion includes a locking portion that is locked to a wall surface of the press-fitting recess in the press-fitted state of being press-fitted into the press-fitting recess.

With this configuration, it is easy to suppress the dislodgment of the contacting member from the housing.

(6) It is preferable that the locking portion includes first locking portions that respectively protrude from the sandwiched portion toward a left side and a right side in a direction intersecting a front-back direction, and a second locking portion that protrudes forward from the sandwiched portion.

With this configuration, it is possible to more reliably suppress the dislodgment of the sandwiched portion from the press-fitting recess.

### DETAILS OF EMBODIMENTS OF THE PRESENT DISCLOSURE

### Embodiment 1

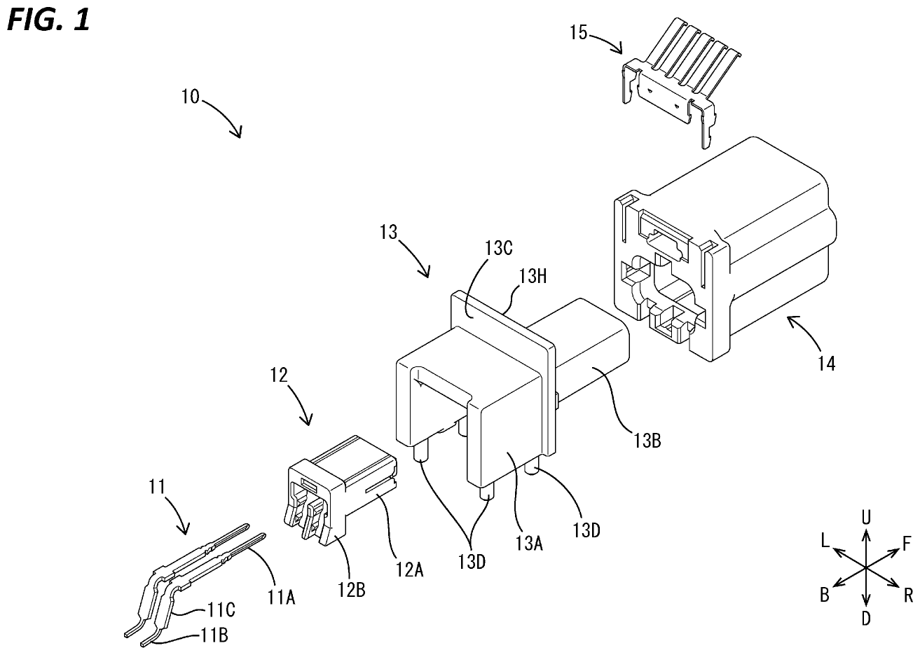

The following describes Embodiment 1 in which a connector of the present disclosure is embodied, with reference to FIGS. 1 to 7. In the diagrams, the “front side”, the “back side”, the “upside”, the “downside”, the “right side”, and the “left side” are represented by “F”, “B”, “U”, “D”, “R”, and “L”, respectively. In Embodiment 1, the left-right direction corresponds to a width direction. A side on which a partner housing 30 is to be fitted into a housing 14 is taken as the front side. A connector 10 is a board connector to be mounted on a circuit board S. As shown in FIG. 1, the connector 10 includes an inner conductor 11, a dielectric 12, a die-cast outer conductor 13, a housing 14, and a contacting member 15.

### <Configuration of Inner Conductor>

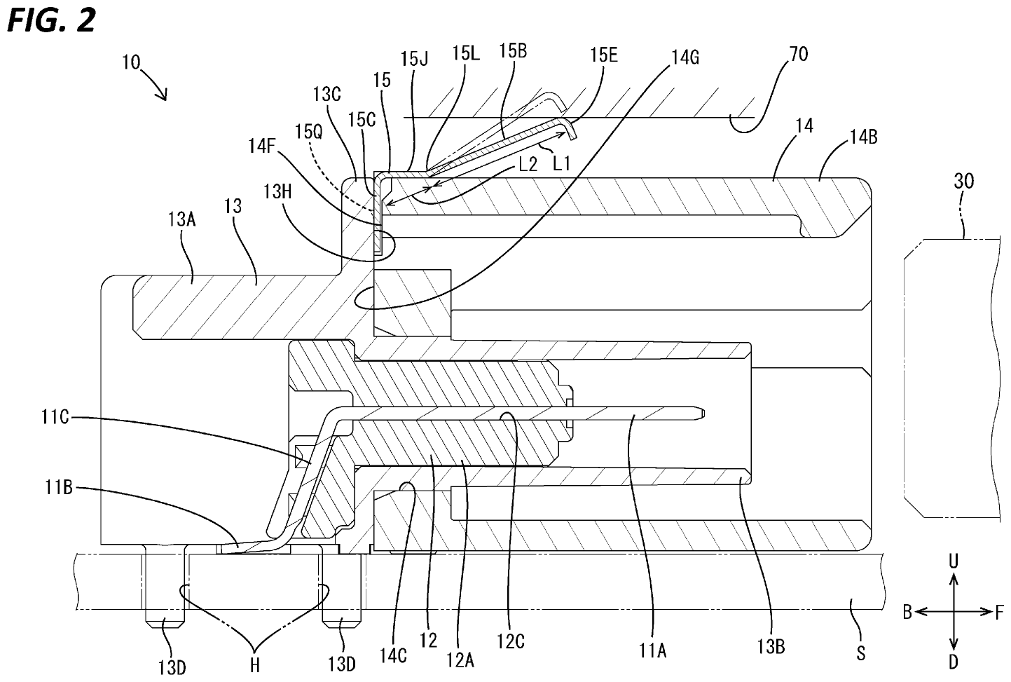

The inner conductor 11 is formed using a conductive metal plate material and has an elongated shape as a whole. The inner conductor 11 includes a partner connection portion 11A, a board connection portion 11B, and a linking portion 11C located between the partner connection portion 11A and the board connection portion 11B. The partner connection portion 11A extends in the front-back direction. As shown in FIG. 2, the back portion of the partner connection portion 11A is held by the dielectric 12 and the front portion of the partner connection portion 11A protrudes forward from the dielectric 12. The linking portion 11C and the board connection portion 11B are located on the back side of the dielectric 12 and are exposed. The linking portion 11C obliquely extends backward and downward from the back end of the partner connection portion 11A. The board connection portion 11B extends backward from the lower end of the linking portion 11C and is to be soldered to the conductive portion of the circuit board S.

### <Configuration of Dielectric>

The dielectric 12 is made of an insulating synthetic resin material and has a block shape as a whole as shown in FIG. 1. The dielectric 12 has an L-shape in a side view. The dielectric 12 includes a terminal attachment portion 12A extending in the front-back direction, and a terminal extraction portion 12B that is continuous with the back end of the terminal attachment portion 12A and extends in a vertical direction. The terminal attachment portion 12A includes a pair of left and right attachment holes 12C (see FIG. 2). The attachment holes 12C pass through the terminal attachment portion 12A in the front-back direction. The partner connection portion 11A is inserted into the attachment hole 12C from the back side. The back portion of the partner connection portion 11A is held in the state of being press-fitted in the attachment hole 12C.

### <Configuration of Die-Cast Outer Conductor>

The die-cast outer conductor 13 is, for example, a cast body formed through zinc die-casting or the like. The dielectric 12 into which the inner conductor 11 is fitted is placed inside the die-cast outer conductor 13 (see FIG. 2). The die-cast outer conductor 13 serves as a shielding member for suppressing the entrance of noise from the outside into the inner conductor 11 as well as suppressing the leakage of noise from the inner conductor 11 to the outside. A hood portion 13B surrounds, without leaving any gaps, the outer periphery of the partner connection portion 11A, thus making it possible to ensure favorable shielding ability.

The die-cast outer conductor 13 includes an outer conductor body 13A, a hood portion 13B extending forward from the outer conductor body 13A, and the plate-shaped flange portion 13C extending outward from the outer conductor body 13A in a flange shape. The outer conductor body 13A has a gate shape in a back view. The front end of the outer conductor body 13A is continuous with the back surface of the flange portion 13C.

The outer conductor body 13A has the shielding ability as well as a function of preventing interference of foreign matter from the outside with the board connection portion 11B of the inner conductor 11. Also, the function of preventing the interference of foreign matter with the board connection portion 11B may be enhanced by attaching, to the outer conductor body 13A, a blocking member (not illustrated) for blocking the back end of the outer conductor body 13A. The outer conductor body 13A includes a plurality of installation protrusions 13D extending downward from the lower ends of the left and right side walls. Each of the installation protrusions 13D has a cylindrical shape and is to be inserted into an installation hole H formed in the circuit board S (see FIG. 2).

The hood portion 13B has a rectangular tubular shape with four rounded corners. As shown in FIG. 2, the terminal attachment portion 12A of the dielectric 12 can be fitted into the inner back portion of the hood portion 13B. The front portion of the partner connection portion 11A of the inner conductor 11 is placed inside the hood portion 13B so as to protrude forward.

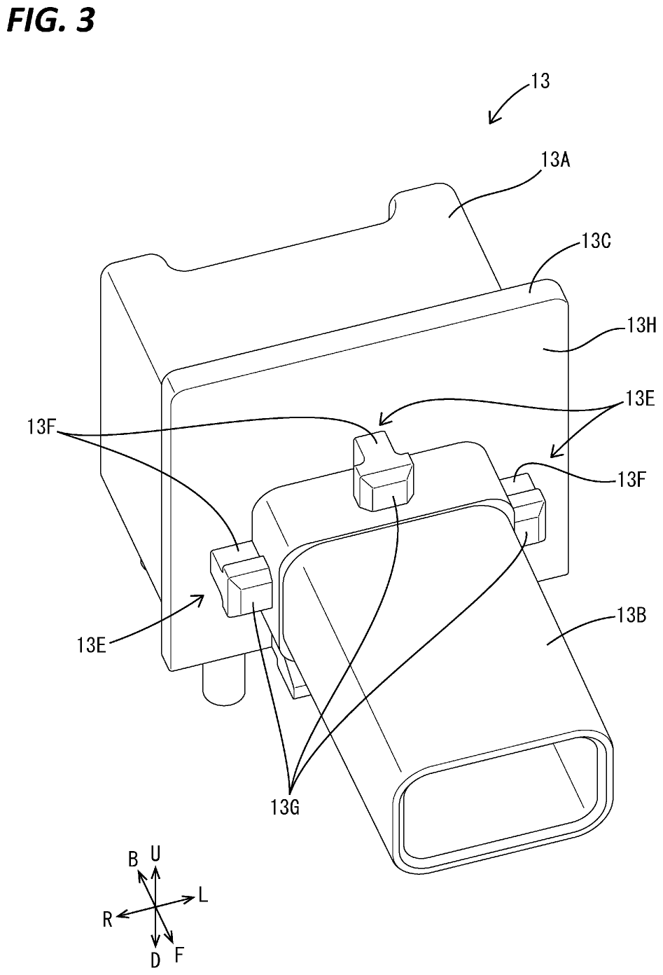

As shown in FIG. 3, the flange portion 13C has a flat plate shape and protrudes radially outward from the base end of the hood portion 13B. The front surface of the flange portion 13C is a front-facing opposed surface 13H that faces forward in the die-cast outer conductor 13. The die-cast outer conductor 13 includes a plurality of locking protrusions 13E that protrude forward from the front-facing opposed surface 13H of the flange portion 13C. Each of the locking protrusions 13E is also coupled to the outer peripheral surface of the hood portion 13B, in the front-back direction. The locking protrusions 13E are inserted into and locked to locking recesses 14D of the housing 14, which will be described later. Each of the locking protrusions 13E includes a protruding body 13F having a rectangular block shape, and a press-fitting protrusion 13G projecting from the front end of the protruding body 13F in a direction intersecting the front-back direction.

### <Configuration of Housing>

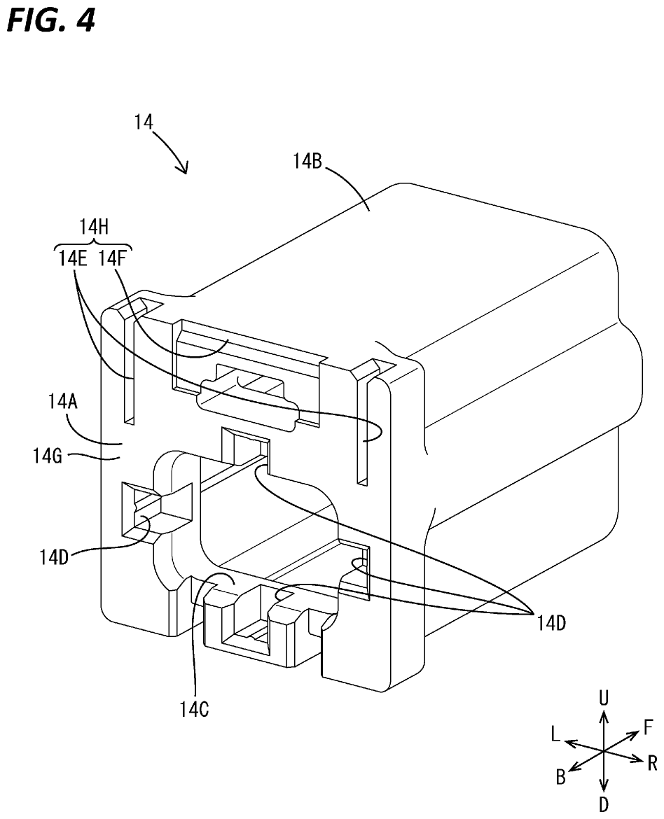

The housing 14 is made of an insulating synthetic resin material. As shown in FIG. 4, the housing 14 includes a base wall 14A having a flat plate shape with a rectangular shape in a back view, and a fitting tube portion 14B that has a rectangular tube shape and protrudes forward from the base wall 14A. The partner housing 30 is to be fitted into the fitting tube portion 14B (see FIG. 2). The back surface of the base wall 14A is a back-facing opposed surface 14G that faces backward in the housing 14.

The base wall 14A is provided with a through hole 14C passing therethrough. The hood portion 13B of the die-cast outer conductor 13 is inserted into the through hole 14C (see FIG. 2). The base wall 14A is provided with a plurality of locking recesses 14D. Each of the locking recesses 14D has a rectangular cross section and is recessed forward from the back-facing opposed surface 14G, and the front end thereof is blocked inside the base wall 14A. The inner end of each locking recess 14D that faces inward in a radial direction is open so as to be communication with the through hole 14C.

A press-fitting recess 14H that is recessed forward is provided at the upper end of the back-facing opposed surface 14G of the base wall 14A. The press-fitting recess 14H includes a first press-fitting recess 14F and a pair of second press-fitting recesses 14E. The first press-fitting recess 14F is formed at the center of the base wall 14A in the left-right direction. The first press-fitting recess 14F is recessed forward from the back-facing opposed surface 14G of the base wall 14A, and the front end thereof is blocked inside the base wall 14A. The first press-fitting recess 14F corresponds to a first sandwiched portion 15C of the contacting member 15, which will be described later. The upper end of the first press-fitting recess 14F is open upward.

One of the pair of second press-fitting recesses 14E is formed at one end of the base wall 14A in the left-right direction, and the other second press-fitting recess 14E is formed at the other end of the base wall 14A. The first press-fitting recess 14F is located between the pair of second press-fitting recesses 14E. These second press-fitting recesses 14E correspond to second sandwiched portions 15D of the contacting member 15, which will be described later. Each of the second press-fitting recesses 14E is recessed forward from the back-facing opposed surface 14G of the base wall 14A, and the front end thereof is blocked inside the base wall 14A. The upper ends of the second press-fitting recesses 14E are open upward. In other words, the second press-fitting recesses 14E are open in the outer surface (top surface) of the housing 14. The second press-fitting recesses 14E are open in the back-facing opposed surface 14G of the housing 14.

### <Configuration of Contacting Member>

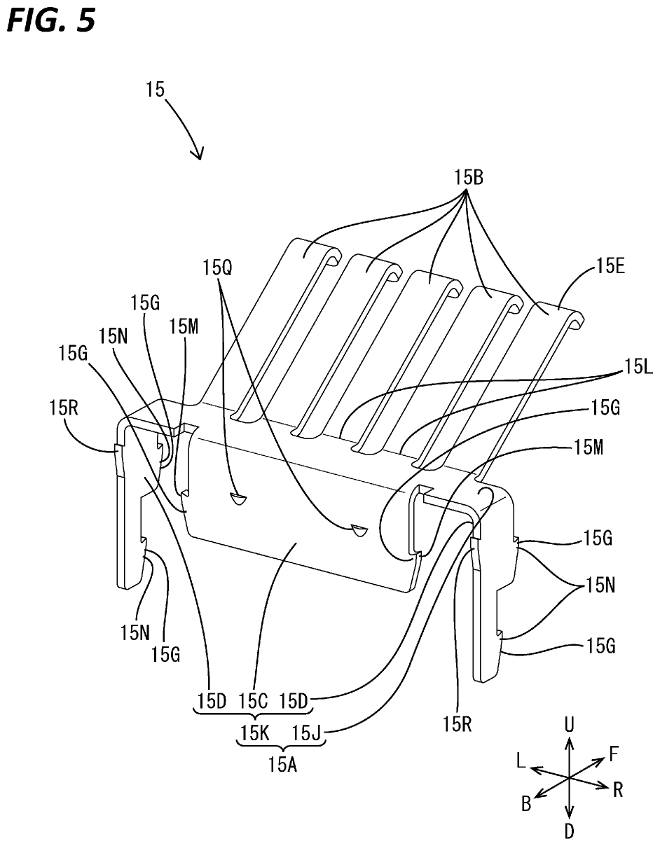

The contacting member 15 is formed in one piece by, for example, bending a metal plate. As shown in FIG. 5, the contacting member 15 includes a coupling portion 15A to be attached to the outer surface (top surface) of the housing 14, and elastic contacting portions 15B that are coupled to the front end of the coupling portion 15A. The coupling portion 15A includes a coupling body 15J and a sandwiched portion 15K. The sandwiched portion 15K includes a first sandwiched portion 15C and a pair of second sandwiched portions 15D. The coupling body 15J has a flat plate shape that extends in the width direction in parallel with the top surface (outer surface) of the housing 14.

The first sandwiched portion 15C protrudes downward from the back end of the central portion of the coupling body 15J in the left-right direction. The thickness direction of the first sandwiched portion 15C extends in the front-back direction. The first sandwiched portion 15C has a rectangular shape as viewed in the front-back direction. The first sandwiched portion 15C is provided with a pair of first locking portions 15M corresponding to the locking portion 15G, and a pair of first back-facing locking portions 15Q. One of the pair of first locking portions 15M protrudes outward in the left-right direction intersecting the front-back direction from one of the two edges of the first sandwiched portion 15C in the left-right direction, and the other first locking portion 15M protrudes outward in the left-right direction intersecting the front-back direction from the other edge of the first sandwiched portion 15C in the left-right direction. Each of the first locking portions 15M obliquely extends outward in the left-right direction such that the width gradually increases from the lower end toward the upper end, and an upside-facing cut surface is formed at the upper end.

The pair of first back-facing locking portions 15Q protrude backward from the back surface of the first sandwiched portion 15C. One of these first back-facing locking portions 15Q is provided at one end of the back surface of the first sandwiched portion 15C in the left-right direction, and the other first back-facing locking portion 15Q is provided at the other end of the back surface of the first sandwiched portion 15C. Each of the first back-facing locking portions 15Q obliquely extends so as to gradually protrude backward from the lower end toward the upper end, and an upside-facing cut surface is formed at the upper end.

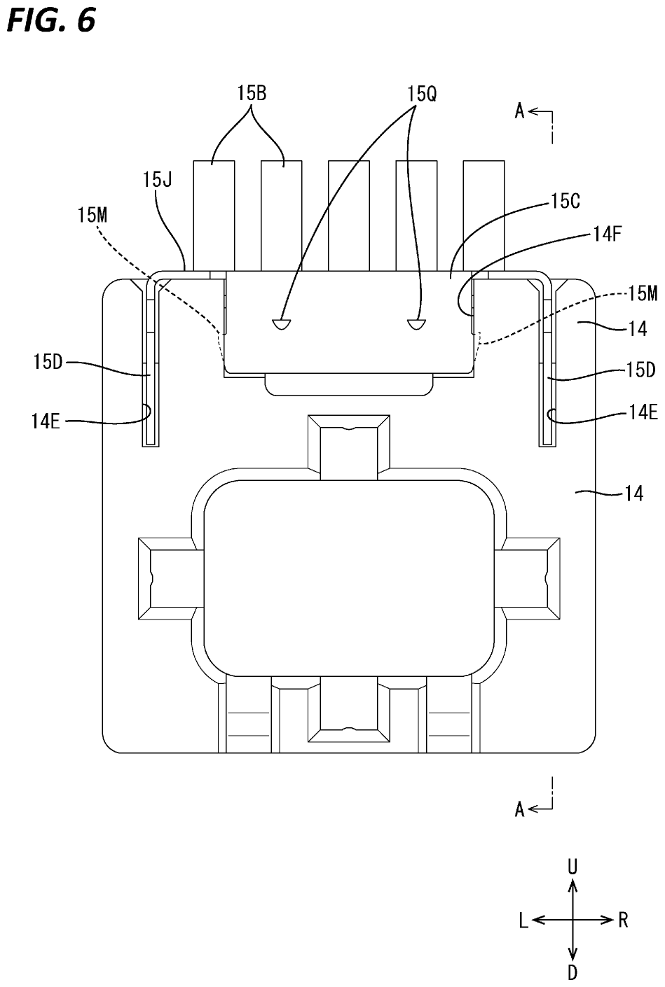

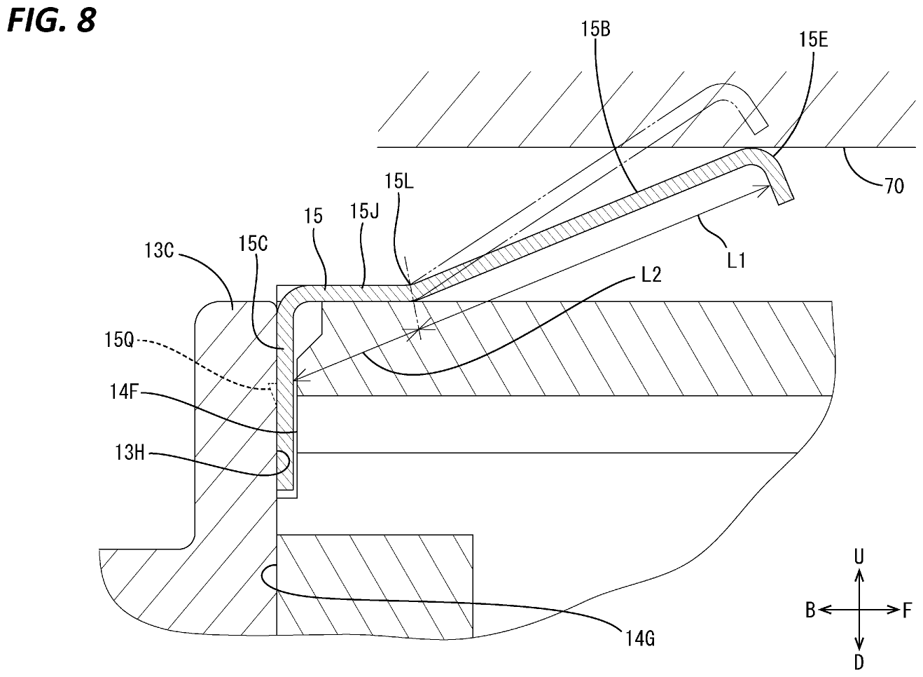

As shown in FIG. 6, the first sandwiched portion 15C is inserted into the first press-fitting recess 14F of the housing 14 from above, and is then placed in the first press-fitting recess 14F in a press-fitted state. In this press-fitted state, the first locking portions 15M bite into and are locked to the wall surfaces of the first press-fitting recess 14F that face inward in the left-right direction. As a result, the first sandwiched portion 15C is placed inside the first press-fitting recess 14F in the press-fitted state, and the dislodgment from the first press-fitting recess 14F is suppressed. The pair of first back-facing locking portions 15Q bite into and are locked to the front-facing opposed surface 13H of the die-cast outer conductor 13 that blocks the first press-fitting recess 14F from the back side in the fitted state in which the die-cast outer conductor 13 is fitted to the housing 14 (see FIGS. 2 and 8). This also suppresses the dislodgment of the first sandwiched portion 15C from the first press-fitting recess 14F.

As shown in FIG. 5, one of the pair of second sandwiched portions 15D protrudes downward from one end of the coupling body 15J in the width direction (left-right direction), and the other second sandwiched portion 15D protrudes downward from the other end of the coupling body 15J. The thickness directions of these second sandwiched portions 15D extend in the left-right direction. The second sandwiched portions 15D have a stepped shape formed by cutting out a rectangular piece from the front portion of the lower portion, in a side view. The lower ends of the second sandwiched portions 15D are located below the lower end of the first sandwiched portion 15C.

Each of the second sandwiched portions 15D is provided with second locking portions 15N corresponding to the locking portion 15G, and a second back-facing locking portion 15R. One of the second locking portions 15N protrudes forward from the front end of the upper portion of the second sandwiched portion 15D, and the other second locking portion 15N protrudes forward from the front end of the lower portion of the second sandwiched portion 15D. Each of the second locking portions 15N obliquely extends forward such that the protrusion amount gradually increases from the lower end toward the upper end, and an upside-facing cut surface is formed at the upper end. The second back-facing locking portion 15R protrudes backward from the back end of the upper portion of the second sandwiched portion 15D. The second back-facing locking portion 15R obliquely extends backward such that the protrusion amount gradually increases from the lower end toward the upper end, and an upside-facing cut surface is formed at the upper end. The amount of the protrusion of the second back-facing locking portion 15R from the second sandwiched portion 15D is smaller than the amount of the protrusion of each second locking portion 15N from the second sandwiched portion 15D.

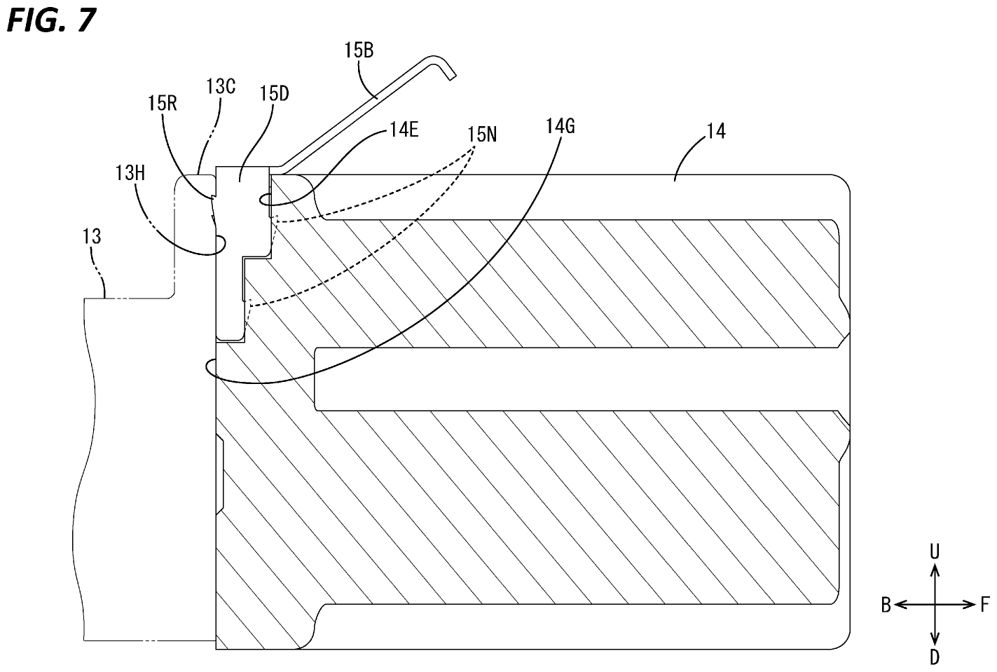

Each of the second sandwiched portions 15D is inserted, from above, into the second press-fitting recess 14E of the housing 14 whose back side is blocked by the flange portion 13C of the die-cast outer conductor 13, and is then placed inside the second press-fitting recess 14E in the press-fitted state. In this press-fitted state, the second locking portions 15N bite into and are locked to the wall surface that is located at the front end of the second press-fitting recess 14E and faces backward (see FIG. 7). At the same time, the second back-facing locking portion 15R bites into and is locked to the front-facing opposed surface 13H of the die-cast outer conductor 13 that blocks the second press-fitting recesses 14E from the back side in the fitted state in which the die-cast outer conductor 13 is fitted to the housing 14 (see FIG. 7). As a result, the second sandwiched portions 15D are placed inside the second press-fitting recesses 14E in the press-fitted state, and the dislodgment from the second press-fitting recesses 14E is suppressed.

A plurality of (five in Embodiment 1) elastic contacting portions 15B are lined up in the left-right direction at the front end of the coupling portion 15A. The elastic contacting portions 15B have the same shape. Each of the elastic contacting portions 15B obliquely extends forward and upward from the front end of the coupling body 15J. Each of the elastic contacting portions 15B is capable of being elastically deformed in the vertical direction with a portion coupled to the front end of the coupling body 15J taken as a fulcrum portion 15L. The fulcrum portion 15L is continuous with the front side of the first sandwiched portion 15C via the coupling body 15J.

In each of the elastic contacting portions 15B, atop portion 15E that is convex upward is formed by bending downward the leading end in the extension direction. The grounding member 70, which is a conductive casing, is attached to the circuit board S to which the connector 10 is attached, so as to cover the connector 10 (see FIG. 2). Then, the top portions 15E of the elastic contacting portions 15B are pressed downward by the inner surface of the grounding member 70 and are elastically deformed, and thus the state in which the elastic contacting portions 15B are in elastic contact with the inner surface of the grounding member 70 is maintained (see FIGS. 2 and 8). As a result, the contacting member 15 is electrically connected to the grounding member 70.

### <Assembly of Connector>

First, the hood portion 13B of the die-cast outer conductor 13 is inserted into the through hole 14C of the housing 14 from the back side. At the final stage of the insertion process, the locking protrusions 13E are inserted into the locking recesses 14D from the back side. When the front-facing opposed surface 13H of the flange portion 13C of the die-cast outer conductor 13 is opposed to and abuts against the back-facing opposed surface 14G of the base wall 14A, the operation of attaching the die-cast outer conductor 13 is stopped (see FIG. 2). Thus, the flange portion 13C is placed so as to block the openings of the first press-fitting recess 14F and the pair of second press-fitting recesses 14E in the back-facing opposed surface 14G of the housing 14 from the back side (see FIGS. 2 and 7). The outer conductor body 13A is placed behind the housing 14 and is lined up with the housing 14 (see FIG. 2).

When the locking protrusions 13E are properly inserted into the locking recesses 14D, each of the press-fitting protrusions 13G comes into contact, in the press-fitted state, with the opposed surface of the locking recess 14D that is opposed to the press-fitting protrusion 13G in the circumferential direction. Thus, the locking protrusions 13E are locked to the locking recesses 14D, and the die-cast outer conductor 13 is held in a state in which dislodgment from the housing 14 is prevented.

Next, the dielectric 12 into which the inner conductor 11 is press-fitted is attached to the die-cast outer conductor 13. Specifically, in a state in which the terminal attachment portion 12A faces forward and the board connection portion 11B of the inner conductor 11 is located at the lower end, the terminal attachment portion 12A is press-fitted into the hood portion 13B of the die-cast outer conductor 13 (see FIG. 2).

Next, the contacting member 15 is attached to the housing 14. Specifically, the contacting member 15 is brought into an orientation where the elastic contacting portions 15B are located on the front side and the first sandwiched portion 15C and the pair of second sandwiched portions 15D protrude downward. Then, the first sandwiched portion 15C is press-fitted into the first press-fitting recess 14F, and the pair of second sandwiched portions 15D are press-fitted into the pair of second press-fitting recesses 14E of the housing 14 (see FIG. 6). Then, when the coupling body 15J comes into contact with the top surface of the housing 14, the attachment of the contacting member 15 to the housing 14 is completed (see FIG. 2). At this time, the fulcrum portions 15L are supported on the upper surface (outer surface) of the housing 14. In addition, the first sandwiched portion 15C and the pair of second sandwiched portions 15D are sandwiched between the front-facing opposed surface 13H and the back-facing opposed surface 14G (see FIGS. 2 and 7).

At this time, the first back-facing locking portions 15Q of the first sandwiched portion 15C bite into the front-facing opposed surface 13H of the flange portion 13C that blocks the first press-fitting recess 14F from the back side (see FIGS. 2 and 8). At the same time, the second back-facing locking portions 15R of the pair of second sandwiched portions 15D bite into the front-facing opposed surface 13H of the flange portion 13C that blocks the second press-fitting recesses 14E from the back side (see FIG. 7). Thus, the contacting member 15 and the die-cast outer conductor 13 come into electrical contact with each other. In this manner, the connector 10 is completed.

Next, the connector 10 is attached to the circuit board S. Then, the grounding member 70 is attached to the circuit board S so as to cover the connector 10. As a result, the top portions 15E of the elastic contacting portions 15B are pressed downward by the inner surface of the grounding member 70, and the state in which the elastic contacting portions 15B are elastically deformed is maintained (see FIGS. 2 and 8). The elastic contacting portions 15B extend forward from the front side of the fulcrum portions 15L while extending upward in the direction away from the upper surface (outer surface) of the housing 14, and come into elastic contact with the grounding member 70 (see FIGS. 2 and 8). At this time, a distance L1 from the contact position at which the top portion 15E of the elastic contacting portion 15B is in contact with the grounding member 70 to the fulcrum portion 15L is larger than a direct distance L2 from a position at which the first back-facing locking portion 15Q of the first sandwiched portion 15C is in contact with the front-facing opposed surface 13H to the fulcrum portion 15L (see FIGS. 2 and 8). At this time, due to the elastic deformation of the elastic contacting portions 15B, stresses in the backward rotational direction about the fulcrum portions 15L occur in the first sandwiched portion 15C and the two second sandwiched portions 15D. These stresses occur in the direction in which the first back-facing locking portions 15Q and the pair of second back-facing locking portions 15R bite into the front-facing opposed surface 13H of the flange portion 13C, thus making it possible to more reliably establish electric continuity between the die-cast outer conductor 13 and the grounding member 70 via the contacting member 15.

Next, the effects of this configuration are shown as examples.

The connector 10 includes: the inner conductor 11; the die-cast outer conductor 13 that surrounds the outer periphery of the inner conductor 11; the housing 14 to which the die-cast outer conductor 13 is fitted; and the contacting member 15 that is to be in electric contact with the external grounding member 70 and the die-cast outer conductor 13. The contacting member 15 includes the sandwiched portion 15K, the fulcrum portions 15L, and the elastic contacting portions 15B. When a side on which the partner housing 30 is to be fitted into the housing 14 is taken as a front side, the sandwiched portion 15K is sandwiched between the front-facing opposed surface 13H of the die-cast outer conductor 13 that faces forward and the back-facing opposed surface 14G of the housing 14 that faces backward. The fulcrum portions 15L are continuous with the front side of the sandwiched portion 15K. The elastic contacting portions 15B extend forward from the front side of the fulcrum portions 15L while extending in the direction away from the outer surface of the housing 14 and come into contact with the grounding member 70, and are capable of being elastically deformed. With this configuration, when the elastic contacting portions 15B are pressed toward the housing 14, a force in a direction in which the sandwiched portion 15K is pressed against the front-facing opposed surface 13H of the die-cast outer conductor 13 can be applied via the fulcrum portions 15L, thus making it possible to bring the contacting member 15 into favorable contact with both the die-cast outer conductor 13 and the grounding member 70.

The fulcrum portions 15L are supported by the outer surface of the housing 14. With this configuration, the positions of the fulcrum portions 15L are unlikely to be shifted, and when a pressing force is applied in a direction in which the elastic contacting portions 15B are allowed to come close to the housing 14, this pressing force can be efficiently converted via the fulcrum portions 15L into a force in a direction in which the sandwiched portion 15K is pressed against the front-facing opposed surface 13H of the die-cast outer conductor 13.

The distance L1 from a contact position at which the elastic contacting portion 15B is in contact with the grounding member 70 to the fulcrum portion 15L is larger than the direct distance L2 from a position at which the sandwiched portion 15K is in contact with the front-facing opposed surface 13H to the fulcrum portion 15L. With this configuration, the distance L1 from the contact position at which the elastic contacting portion 15B is in contact with the grounding member 70 to the fulcrum portion 15L (i.e., a distance from the point of effort to the fulcrum) is larger than the direct distance L2 from a position at which the sandwiched portion 15K is in contact with the front-facing opposed surface 13H of the die-cast outer conductor 13 to the fulcrum portion 15L (i.e., a direct distance from the point of action to the fulcrum), thus making it possible to more efficiently apply, to the sandwiched portion 15K, the force in the direction in which the sandwiched portion 15K is pressed against the front-facing opposed surface 13H.

The housing 14 includes the press-fitting recess 14H that is recessed in the back-facing opposed surface 14G, the sandwiched portion 15K is placed in the press-fitting recess 14H in a press-fitted state, and the press-fitting recess 14H is blocked by the front-facing opposed surface 13H in a fitted state in which the die-cast outer conductor 13 is fitted. With this configuration, it is easy to simplify a mold structure for forming the press-fitting recess 14H in the housing 14.

The sandwiched portion 15K includes the locking portion 15G that is locked to the wall surface of the press-fitting recess 14H in the press-fitted state of being press-fitted into the press-fitting recess 14H. With this configuration, it is easy to suppress the dislodgment of the contacting member 15 from the housing 14.

The locking portion 15G includes the first locking portions 15M that respectively protrude from the first sandwiched portion 15C toward the left side and the right side in a direction intersecting a front-back direction, and the second locking portions 15N that protrude forward from the second sandwiched portions 15D. With this configuration, it is possible to more reliably suppress the dislodgment of the first sandwiched portion 15C and the second sandwiched portions 15D from the first press-fitting recess 14F and the second press-fitting recesses 14E.

### OTHER EMBODIMENTS

The embodiments disclosed herein are exemplary in all respects, and should be construed as being not limitative. The scope of the present invention is not limited to the embodiments disclosed herein and is defined by the scope of the appended claims, and all changes that fall within the same essential spirit as the scope of the claims are intended to be included therein.

Unlike Embodiment 1, the second sandwiched portion may be provided with a locking portion that protrudes from the plate surface in the left-right direction. In addition, the first sandwiched portion may also be provided with a locking portion protruding forward instead of the back-facing locking portion.

Unlike Embodiment 1, the die-cast outer conductor may also be made of a material such as an aluminum alloy through die-casting.

Unlike Embodiment 1, a procedure may also be employed in which the connection member is attached to the housing and then the die-cast outer conductor is attached to the housing.

Unlike Embodiment 1, the flange portion may protrude only upward.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
an inner conductor;
a die-cast outer conductor that surrounds an outer periphery of the inner conductor;
a housing to which the die-cast outer conductor is fitted; and
a contacting member that is to be in electric contact with an external grounding member and the die-cast outer conductor,
wherein, when a side on which a partner housing is to be fitted into the housing is taken as a front side,
the contacting member includes:
a sandwiched portion that is sandwiched between a front-facing opposed surface of the die-cast outer conductor that faces forward and a back-facing opposed surface of the housing that faces backward;
a fulcrum portion that is continuous with a front side of the sandwiched portion; and
an elastic contacting portion capable of being elastically deformed that extends forward from a front side of the fulcrum portion while extending in a direction away from an outer surface of the housing and comes into contact with the grounding member.

2. The connector according to claim 1,
wherein the fulcrum portion is supported by an outer surface of the housing.

3. The connector according to claim 2,
wherein a distance from a contact position at which the elastic contacting portion is in contact with the grounding member to the fulcrum portion is larger than a direct distance from a position at which the sandwiched portion is in contact with the front-facing opposed surface to the fulcrum portion.

4. The connector according to claim 1,
wherein the housing includes a press-fitting recess that is recessed in the back-facing opposed surface,
the sandwiched portion is placed in the press-fitting recess in a press-fitted state, and
the press-fitting recess is blocked by the front-facing opposed surface in a state in which the die-cast outer conductor is attached.

5. The connector according to claim 4,
wherein the sandwiched portion includes a locking portion that is locked to a wall surface of the press-fitting recess in the press-fitted state of being press-fitted into the press-fitting recess.

6. The connector according to claim 5,
wherein the locking portion includes first locking portions that respectively protrude from the sandwiched portion toward a left side and a right side in a direction intersecting a front-back direction, and a second locking portion that protrudes forward from the sandwiched portion.
